(19) United States
(12) Patent Application Publication
(10) Pub. No.: US 2003/0210407 A1
(43) Pub. Date: Nov. 13, 2003

(54) Image processing method, image processing system and image processing apparatus

(75) Inventor: Gang Xu, Otsu-shi (JP)

Correspondence Address: BIRCH STEWART KOLASCH & BIRCH, PO BOX 747, FALLS CHURCH, VA, 22040-0747, US

(73) Assignee: 3D Media Co., Ltd., Otsu-shi (JP)

(21) Appl. No.: 10/340,647

(22) Filed: Jan. 13, 2003

(30) Foreign Application Priority Data
May 13, 2002 (JP) 2002-137673
Oct. 1, 2002 (JP) 2002-289178

(51) Int. Cl. G01B 11/24

(52) U.S. Cl. 356/611

(57) ABSTRACT

An image processing system includes: image capture apparatuses 10P and 10Q for capturing images of an object T; a light emitting apparatus 20 having a plurality of light emitting units L₁ through L₈ and a controller 21 for controlling on/off of the light emitting units L₁ through L₈; and an image processing apparatus 30 capable of performing image processing. The image processing apparatus 30 extracts feature points on the basis of an optical image formed on the object T by light emitted from the light emitting apparatus 20, correlates feature points on a plurality of images with each other, and calculates positions and orientations of the image capture apparatuses 10P and 10Q on the basis of the correlated feature points. With the image processing apparatus, image processing system and the image processing method using them, extraction of feature points from images and correlation of them can be easily performed.

### BACKGROUND OF THE INVENTION

1. Field of the Invention

The present invention relates to a method, system and apparatus for performing image processing by artificially forming feature points to be used for finding correspondence between a plurality of images.

2. Description of Related Art

Along with the advancement of image processing technology of late years, technique for creating a three-dimensionally shaped model using a plurality of two-dimensional images, for measuring a three-dimensional shape, and for composing a two-dimensional panorama image by stitching a plurality of two-dimensional images is vigorously developed.

The following description will explain a conventional method for creating a three-dimensionally shaped model. For creating a three-dimensionally shaped model, images of an object are captured from a plurality of view points using a digital camera or a silver salt film camera. The captured two-dimensional images are then read into an image processing apparatus, such as a personal computer, capable of performing image processing. Two-dimensional images captured by a silver salt film camera are read into the image processing apparatus after digitalized by an optical reader such as a scanner.

FIG. 1 is a schematic view illustrating the arrangement employed for capturing images of an object. FIG. 2 is a schematic view for explaining the relationship between captured two-dimensional images. Reference numerals 10P and 10Q in the figures indicate image capture apparatuses, such as digital cameras or silver salt film cameras, for capturing images of an object T. Images captured by the image capture apparatuses 10P and 10Q are read into the image processing apparatus in the above-mentioned method. When images of an object T which includes a cubic object and a triangular-pyramid object are captured by the image capture apparatuses 10P and 10Q as shown in FIG. 1, the images show the object T as shapes with different orientations due to different view points of the image capture apparatuses. For example, an image 100P is captured by the image capture apparatus 10P substantially from the front of the object T, while an image 100Q is captured by the image capture apparatus 10Q obliquely from above the object T.

For creating a three-dimensionally shaped model using such images (two-dimensional images), performed first is determination of points corresponding to each other, on respective two-dimensional images captured from two different view points. On the basis of the determined corresponding points, the positions and orientations of the image capture apparatuses 10P and 10Q at the time of capturing images of the object T are calculated. Then, on the basis of the calculated positions and orientations of the image capture apparatuses 10P and 10Q, modeling of the shape of the object is performed on the principle of triangulation.

For creating a three-dimensionally shaped model in such a manner, it is required to determine points corresponding to each other on respective two-dimensional images. Conventionally, a binary format image, a brightness image, an edge image or the like is created first using the read images, edges of the shape are extracted from the two-dimensional images, and then points which are characteristic of the shape (feature points) are determined on the basis of the information on edges. The feature points determined in respective images are then correlated with each other, to determine corresponding points.

In the example shown in FIG. 2, apexes of the cubic object and triangular-pyramid object are extracted as feature points from each two-dimensional image. Points P₁ through P₁₁ can be extracted as feature points from the image 100P, while points Q₁ through Q₁₁ can be extracted as feature points from the image 100Q. For calculating positions and orientations of the image capture apparatuses 10P and 10Q at the time of capturing images, feature points are correlated with each other to determine pairs of feature points corresponding to each other (corresponding points), such as (P₁, Q₁), (P₂, Q₂), (P₃, Q₃) and others.

When the object T is composed of shapes having apexes such as a cube or triangular pyramid, feature points can be extracted relatively easily. However, when the shape of the object consists of a sphere and/or a cylinder, it is difficult to extract feature points automatically by the image processing apparatus. Consequently, in the conventional approach, there are instances where the number of pairs of corresponding points required for calculating positions and orientations of the image capture apparatuses 10P and 10Q cannot be ensured.

Furthermore, determination of corresponding points requires the steps of creating a binary format image, brightness image or the like on the basis of the read two-dimensional images; extracting feature points from the shape included in the two-dimensional images; and correlating the extracted feature points with each other, for example. Accordingly, there are instances where much computation time is required for determining corresponding points.

### BRIEF SUMMARY OF THE INVENTION

The present invention has been made with the aim of solving the above problems, and it is an object thereof to provide an image processing method, image processing system and image processing apparatus capable of determining corresponding points on respective images which correspond to each other on the basis of an optical image formed by emitted light, to thereby calculate positions and orientations of image capture apparatuses on the basis of the determined corresponding points, even if no feature point can be found in the object to be imaged.

Another object of the invention is to provide an image processing system which can easily correlate positions of optical image spots showing up in a plurality of images with each other.

Another object of the invention is to provide an image processing apparatus capable of obtaining a three-dimensional image easily.

Still another object of the invention is to provide an image processing apparatus capable of creating a composite image easily.

An image processing method according to the present invention comprises the steps of: emitting light on an object; capturing images of the object by an image capture apparatus; reading a plurality of images, captured with light being emitted on the object, into an image processing apparatus; calculating positional information of an optical image formed on the object by emitted light, on the basis of each of the read images; determining corresponding points on respective images which correspond to each other, on the basis of the calculated positional information of the optical image; and calculating positions and orientations of the image capture apparatus at the time of capturing the images of the object, on the basis of the determined corresponding points.

An image processing system according to the present invention comprises: a light emitting apparatus for emitting light on an object; an image capture apparatus for capturing an image of the object; and an image processing apparatus. The image processing apparatus includes: means for reading a plurality of images captured by the image capture apparatus with light being emitted by the light emitting apparatus; means for calculating positional information of an optical image formed on the object by the emitted light, on the basis of each of the read images; means for determining corresponding points on respective images which correspond to each other, on the basis of the calculated positional information of the optical image; and means for calculating positions and orientations of the image capture apparatus at the time of capturing the images of the object, on the basis of the determined corresponding points.

An image processing apparatus according to the present invention comprises: means for reading a plurality of images captured by an image capture apparatus with light being emitted on an object; means for calculating positional information of an optical image formed on the object by the emitted light, on the basis of each of the read images; means for determining corresponding points on respective images which correspond to each other, on the basis of the calculated positional information of the optical image; and means for calculating positions and orientations of the image capture apparatus at the time of capturing the images of the object, on the basis of the determined corresponding points.

With the image processing method, image processing system and image processing apparatus, a plurality of images captured with light being emitted on an object are read, the position of an optical image formed on the object by the emitted light is calculated on the basis of each of the read images, corresponding points on respective images which correspond to each other are determined on the basis of the calculated positional information of the optical image, and positions and orientations of an image capture apparatus at the time of capturing the images are calculated on the basis of the determined corresponding points. Accordingly, even if no feature point can be found in the object to be imaged, optical images formed by light emitted from the light emitting apparatus can be used as feature points. On the basis of the feature points, the image processing apparatus can determine corresponding points on respective images, which correspond to each other. Moreover, computation time required for extracting feature points can be shortened by omitting a process for creating a binary format image, brightness image or the like.

In the image processing system of the invention, the light emitting apparatus may include means for emitting at least one light spot.

With this image processing system, images are captured with the light emitting apparatus emitting at least one light spot. Consequently, even if no feature point can be found in the object to be imaged, an optical image spot of the emitted light can be used as a feature point, and the image processing apparatus can determine a corresponding point on each image, on the basis of the feature point. Moreover, computation time required for extracting a feature point can be shortened by omitting a process for creating a binary format image, brightness image or the like.

In the image processing system of the invention, the light emitting apparatus may include means for emitting a plurality of light spots having respectively unique colors.

With this image processing system, images are captured with a plurality of light spots having respectively unique colors being emitted on the object. Consequently, feature points showing up on the respective images can be easily correlated with each other, and time required for calculating a corresponding point can be shortened.

In the image processing system of the invention, the light emitting apparatus may further include control means for controlling on/off of each emitted light spot.

This image processing system comprises control means for controlling on/off of each emitted light spot. Accordingly, by comparing an image captured while a light spot is emitted and an image captured while no light spot is emitted, feature points showing up on respective images can be easily correlated with each other, and time required for calculating a corresponding point can be shortened.

The image processing system of the invention may further comprise timing means, and the control means may control the on/off on the basis of time outputted from the timing means.

This image processing system comprises control means for controlling on/off of each emitted light spot on the basis of time outputted by the timing means. Accordingly, by comparing an image captured while a light spot is emitted and an image captured while no light spot is emitted, feature points showing up on respective images can be easily correlated with each other, and time required for calculating a corresponding point can be shortened.

The image processing apparatus of the invention may further comprise means for obtaining a three-dimensional image of the object on the basis of the calculated positions and orientations of the image capture apparatus.

With this image processing apparatus capable of obtaining a three-dimensional image on the basis of the calculated positions and orientations of the image capture apparatus, a three-dimensional image can be easily obtained using corresponding points on respective images.

The image processing apparatus of the invention may further comprise means for creating a composite image using the images on the basis of the calculated positions and orientations of the image capture apparatus.

With this image processing apparatus capable of creating a composite image on the basis of the calculated positions and orientations of the image capture apparatus, a composite image can be easily created using corresponding points on respective images.

The above and further objects and features of the invention will more fully be apparent from the following detailed description with accompanying drawings.

### BRIEF DESCRIPTION OF THE SEVERAL VIEWS OF THE DRAWINGS

FIG. 1 is a schematic view illustrating the arrangement employed for capturing images of an object;

FIG. 2 is a schematic view for explaining the relationship between captured two-dimensional images;

FIG. 3 is a block diagram for explaining an image processing system according to an embodiment;

FIG. 4 is an external perspective view of a light emitting apparatus;

FIG. 5 is a schematic view for explaining the relationship between two images captured by image capture apparatuses;

FIG. 6 is a schematic view for explaining the relationship between two images captured by the image capture apparatuses;

FIG. 7 is a flow chart for explaining the processing procedure of an image processing apparatus;

FIG. 8 is a block diagram of the light emitting apparatus used for the image processing system according to another embodiment;

FIG. 9 includes time charts showing lighting timings of light emitting units and imaging timings of the image capture apparatus;

FIGS. 10A through 10C are schematic views for explaining the relationship between images captured by the image processing system according to the embodiment;

FIG. 11 is a block diagram showing the configuration of the image processing system according to still another embodiment; and

FIGS. 12 and 13 are flow charts for explaining the processing procedure of the image processing apparatus according to the embodiment.

### DETAILED DESCRIPTION OF THE INVENTION

The following description will explain the present invention in detail with reference to the drawings illustrating some embodiments thereof.

First Embodiment

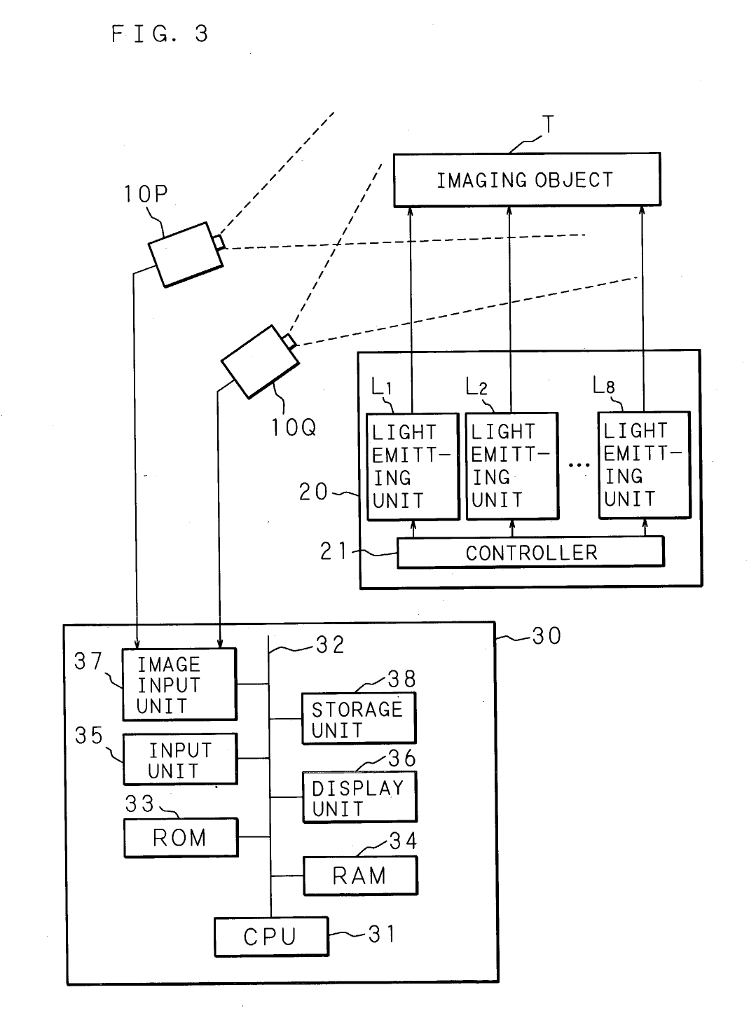

FIG. 3 is a block diagram for explaining an image processing system according to this embodiment. Reference numerals 10P and 10Q in the figure indicate image capture apparatuses, such as silver salt film cameras or digital cameras, for capturing images of an object T. The object T includes a backdrop in addition to objects having three-dimensional shapes. When the image capture apparatuses 10P and 10Q capture images of the object T, a light emitting apparatus 20 emits light so that a predetermined optical image shows up on the object T. Two-dimensional images, which are captured after starting light emission, are read into an image processing apparatus 30, such as a personal computer, capable of performing image processing. The image processing apparatus 30 calculates positional information of an optical image showing up on a plurality of read two-dimensional images, and calculates positions and orientations of the image capture apparatuses 10P and 10Q at the time of capturing images of the object T. The image processing apparatus 30 then creates a three-dimensionally shaped model of the object T on the basis of the calculated positions and orientations of the image capture apparatuses 10P and 10Q. Moreover, the image processing apparatus 30 may be constructed to measure three-dimensional shapes. Furthermore, the image processing apparatus 30 may be constructed to create a two-dimensional panorama image by stitching a plurality of two-dimensional images.

The light emitting apparatus 20 comprises eight light emitting units L₁ through L₈, and a controller 21 for controlling on/off of the light emitting units L₁ through L₈. Each of the light emitting units L₁ through L₈ may preferably have a light source, such as a laser pointer, for emitting a light spot, so as to create an optical image spot on the object T. Although this embodiment employs eight light emitting units L₁ through L₈, it should be understood that the number of the light emitting units is not limited to eight.

The controller 21 has, for example, a button switch (which is not illustrated in the figure) for turning on/off each of the light emitting units L₁ through L₈. Accordingly, each of the light emitting units L₁ through L₈ can be turned on/off manually.

The image processing apparatus 30 comprises a CPU 31. The CPU 31 is connected via a bus 32 with hard ware such as a ROM 33, RAM 34, input unit 35, display unit 36, image input unit 37 and storage unit 38. The ROM 33 stores various kinds of control programs. The CPU 31 controls the hard ware by reading the control programs stored in the ROM 33. The RAM 34 is constituted of a SRAM, flash memory or the like, and stores data generated when the control programs stored in the ROM 33 are executed.

The input unit 35 is constituted of an input device such as a keyboard, mouse or tablet. A user inputs instruction for image processing through the input unit 35, to perform a selection operation or the like. The display unit 36 is constituted of a display device such as a CRT or LCD, and displays images showing the result of performed image processing and the like.

The image input unit 37 is a scanner, film scanner or the like used as an optical image reader, and transforms a silver salt print, photographic film or the like obtained by the image capture apparatuses 10P and 10Q into two-dimensional image data. In place of inputting image data using the image input unit 37, the invention may be constructed to input image data using a reader having a portable memory for storing data of images captured by a digital camera. The inputted image data is then stored in the storage unit 38 such as a hard disk.

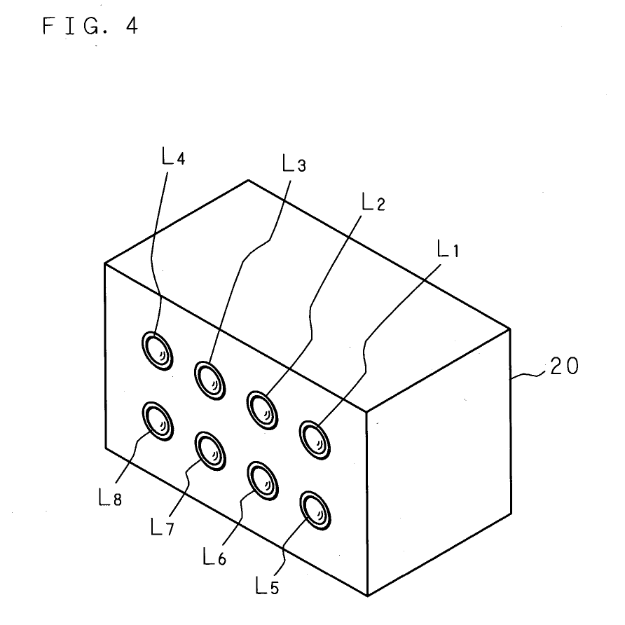

FIG. 4 is an external perspective view of the light emitting apparatus 20. The light emitting apparatus 20 is configured as a case of a rectangular parallelepiped, which has the above-mentioned controller 21 built-in. The case has eight light emitting units L₁ through L₈ on one side thereof. As shown in FIG. 4, four light emitting units L₁ through L₄ are arranged in line in a horizontal direction at an appropriate distance, while the other four light emitting units L₅ through L₈ are arranged in line in a horizontal direction under the four light emitting units L₁ through L₄ at an appropriate distance.

With the arrangement shown in FIG. 4, the physical relationship between the respective light emitting units L₁ through L₈ can be easily figured out, and thereby the physical relationship between the respective optical images created on the object T can be also figured out easily. As a result, correspondence between optical images on a plurality of images can be easily obtained. It should be noted that it is not necessary to fix an optical axis of each of the light emitting units L₁ through L₈ to the case of the light emitting apparatus 20, and the invention may be constructed to change a direction of an optical axis in case of need.

The eight light emitting units L₁ through L₈ are arranged in two columns and four rows in this embodiment, however, it is not necessary to have such an arrangement. For example, the eight light emitting units L₁ through L₈ may be arranged randomly. In this case, since it is difficult to specify corresponding optical images on two images in image processing, it is preferable that the light emitting units L₁ through L₈ respectively emit unique colors. In such a manner, correspondence can be easily obtained by distinguishing colors of the optical images showing up on the object T. There are two leading methods for changing color of outputted light. One is to change an emission color itself, which is realized by using light emitting elements, lasers or the like having different frequency characteristics of outputted light. The other is to change color by passing light through a filter such as a color film immediately before light is outputted to the outside from the light emitting apparatus 20. This method, which does not require light emitting elements, lasers or the like having different frequency characteristics, can be realized at a lower price.

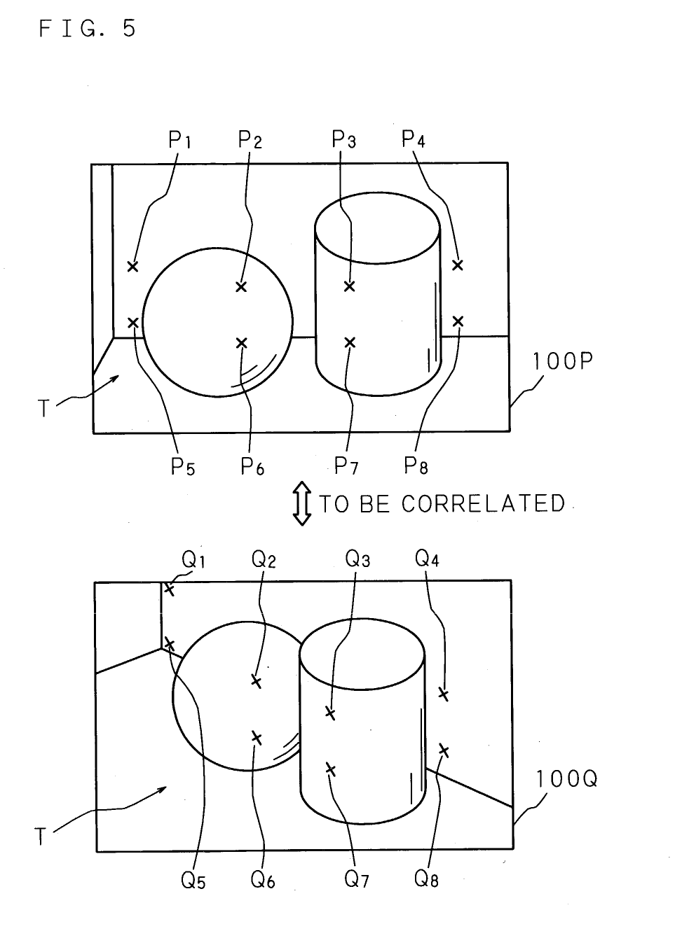

FIG. 5 is a schematic view for explaining the relationship between two images captured by the image capture apparatuses 10P and 10Q. The following description will explain a case where an object T including a bulb-shaped object, a cylindrical object and a backdrop is imaged. A position and a direction of the optical axis of the light emitting apparatus 20 are adjusted so that light emitted from the eight light emitting units L₁ through L₈ of the light emitting apparatus 20 creates optical images on the bulb-shaped object, cylindrical object and backdrop. Subsequently, images of the object T are captured by the image capture apparatuses 10P and 10Q so that the captured images include optical images formed by light emitted from the light emitting units L₁ through L₈.

For example, the image 100P shown in the upper section of FIG. 5 is an image captured by the image capture apparatus 10P, and the image 100Q shown in the lower section is an image captured by the image capture apparatus 10Q. In the image 100P, optical images formed by light emitted from respective light emitting units L₁ through L₈ show up at the positions of points P₁ through P₈ which are respectively x-ed in the figure. In the image 100Q, optical images formed by light emitted from respective light emitting units L₁ through L₈ show up at the positions of points Q₁ through Q₈ which are respectively x-ed in the figure.

In this embodiment, points P₁ through P₈ showing up in the image 100P are correlated with points Q₁ through Q₈ showing up in the image 100Q in a method described below, to determine pairs of points on the two images 100P and 100Q corresponding to each other (corresponding points), such as (P₁, Q₁), (P₂, Q₂), . . . ,(P₈, Q₈).

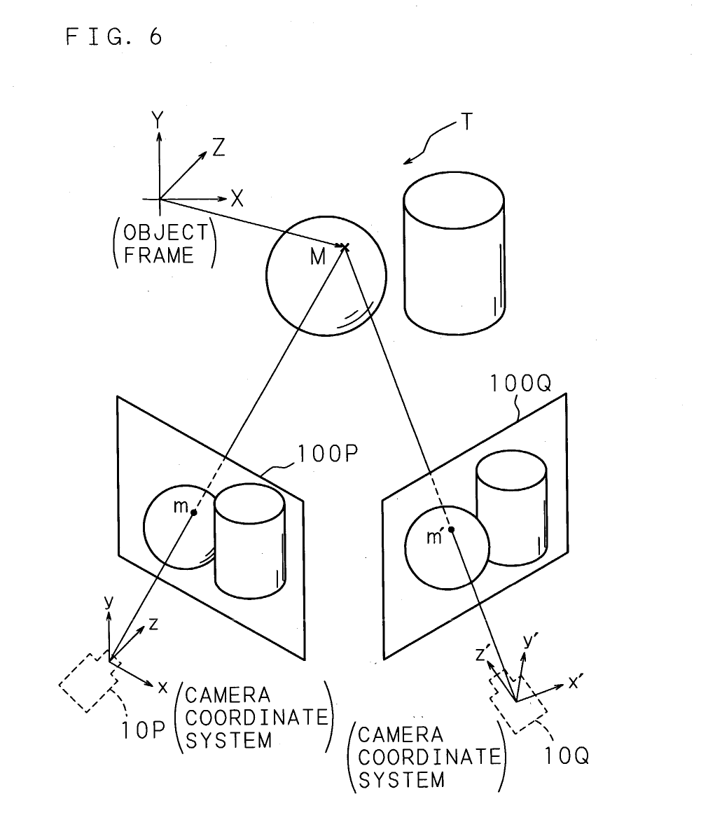

FIG. 6 is a schematic view for explaining the relationship between the two images 100P and 100Q which are captured by the image capture apparatuses 10P and 10Q. The reference symbol M indicates position coordinates of an optical image showing up on the object T, which is coordinates of a three-dimensional space expressed using an object frame independent of positions of the image capture apparatuses 10P and 10Q. Position coordinates m and m′ corresponding to the position of the optical image are expressed using two-dimensional coordinates fixed at each of the images 100P and 100Q, and indicate points in the two images 100P and 100Q, which correspond to each other.

The relationship between position coordinates M in a three-dimensional space and position coordinates m in a two-dimensional image is expressed by the following expression (1), using a projection matrix P.

m≅PM (1)

The projection matrix P is expressed by the following expression (2):

P≅A[R, t] (2)

where the symbol A indicates an intrinsic matrix including camera parameters as elements thereof, and the symbols t and R respectively indicate a translation vector and a rotation matrix between the image capture apparatuses 10P and 10Q. The intrinsic matrix A includes camera parameters as elements, such as the focal length, pixel size, and coordinates of the principal point. Since the progress of camera manufacturing technique of late years enables the pixel size and the coordinates of the principal point to be treated as given values, only the focal length is regarded as an unknown camera parameter.

The projective geometry teaches that the relationship between the position coordinates m and m′ of corresponding points in two images is expressed by the following equation (3):

m^{T}Fm′=0 , (3)

where the symbol F indicates the fundamental matrix. The equation (3) indicates epipolar constraint conditions between the two images 100P and 100Q. The fundamental matrix F with three columns and three rows has zero as one of singular values and arbitrary scale, so that the equation (3) gives seven constraint conditions. In other words, the fundamental matrix F can be found when corresponding points of more than seven pairs exist between two images 100P and 100Q. Practically, taking into consideration the fact that the optical images have finite dimensions and the images 100P and 100Q captured by the image capture apparatuses 10P and 10Q include noise or the like, there are instances where the position coordinates m does not correspond to the position coordinates m′ in a strict sense. In this case, it is preferable to make simultaneous equations on the basis of the equation (3) using corresponding points of more than seven pairs and obtain an appropriate fundamental matrix F in a least-squares method.

The fundamental F can be expressed by the following equation (4), using the above-mentioned intrinsic matrix A, translation vector t, rotation matrix R and an essential matrix E (=[t]×R).

F=A^{-T}EA′⁻¹=A^{-T}[t]×RA′⁻¹ (4)

The fundamental F can be obtained using the equation (3), and the obtained fundamental F gives the essential matrix E. Furthermore, the essential matrix E gives the translation vector t and rotation matrix R.

When the translation vector t and rotation matrix R are obtained, the position coordinates m and m′ on the images 100P and 100Q can be transformed into position coordinates M in an object frame, using the obtained translation vector t and rotation matrix R. However, owing to the influence of noise or the like included in the images 100P and 100Q, transformed position coordinates seldom accord with each other in a three-dimensional space. In other words, when position coordinates M in an object frame is projected on each of the images 100P and 100Q using the translation vector t and rotation matrix R, the projected position coordinates seldom accord with the position coordinates m and m′. Consequently, it is preferable to perform bundle adjustment (optimization) of each element included in the translation vector t and rotation matrix R. The following description will explain the bundle adjustment concretely.

First, position coordinates Mᵢ (i=1, 2, . . . ) of a three-dimensional space in an object frame is projected on each of the images 100P and 100Q using the translation vector t and rotation matrix R, to find position coordinates mᵢ and mᵢ′ on each of the images 100P and 100Q. Next, a performance function is set with regard to the sum of squares of the distances between the found position coordinates mᵢ (position coordinates mᵢ′) and measured position coordinates of optical images showing up on the object T. Each element included in the translation vector t and rotation matrix R is determined to give the minimum value of the set performance function.

As described above, this embodiment enables positions and orientations of the image capture apparatuses 10P and 10Q in an object frame to be obtained as the translation vector t and rotation matrix R, using the images 100P and 100Q captured from two different view points. As a result, the relationship between a camera coordinate system fixed at each of the image capture apparatuses 10P and 10Q and an object frame can be found.

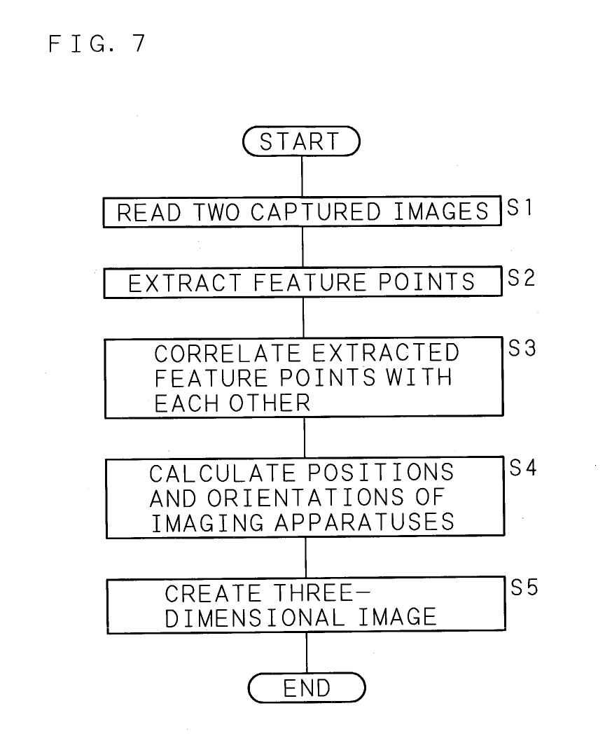

FIG. 7 is a flow chart for explaining the processing procedure of the image processing apparatus 30. First, the CPU 31 of the image processing apparatus 30 reads two images 100P and 100Q (step S1). Images to be read are: images which are captured by the image capture apparatuses 10P and 10Q and then inputted through the image input unit 37; or images which are captured in advance and then stored in the storage unit 38.

Next, the CPU 31 extracts feature points from the two read images 100P and 100Q (step S2). The feature points are extracted by detecting a pixel having the maximum luminance value from each of the read images 100P and 100Q. In a case where the light emitting units L₁ through L₈ of the light emitting apparatus 20 are designed to respectively emit light of different colors, optical images formed by the light emitting apparatus 20 can be detected on the basis of information on colors.

The CPU 31 correlates feature points extracted from the image 100P with feature points extracted from the image 100Q (step S3). Correspondence between feature points can be obtained in a method mentioned below, for example. Each of the images 100P and 100Q includes a finite number of feature points, and thereby possible correspondence between feature points is limited to a finite number of pairs. One pair is selected from these pairs, and a fundamental matrix F is obtained using the equation (3), on the basis of a plurality of pairs of feature points included in the selected pair. If an appropriate pair is selected, one fundamental matrix F can be shared when position coordinates of another pair of feature points corresponding to each other are substituted in the equation (3), while if an inappropriate pair is selected, the fundamental matrix F cannot be shared. Consequently, by checking whether the fundamental matrix F obtained using a plurality of feature points included in each pair can be shared by other pairs of feature points or not, it is possible to examine whether the correspondence between the feature points is appropriate or not, and to correlate feature points in the images 100P and 100Q with each other.

On the basis of a plurality of determined pairs of corresponding points, the CPU 31 calculates positions and orientations of the image capture apparatuses 10P and 10Q in the above-mentioned method (step S4). In this embodiment, eight pairs of corresponding points can be determined on the images. The CPU 31 obtains a fundamental matrix F using the eight pairs of corresponding points, to calculate the translation vector t and rotation matrix R of the image capture apparatuses 10P and 10Q.

The CPU 31 then creates a three-dimensional image on the basis of the calculated positions and orientations of the image capture apparatuses 10P and 10Q (step S5). Since the translation vector t and rotation matrix R of the image capture apparatuses 10P and 10Q have already been obtained in the step S4, position coordinates on the images can be transformed into position coordinates of a three-dimensional space in an object frame using the expressions (1) and (2), so that a three-dimensional image can be restructured.

It should be noted that, although this embodiment employs the structure for creating a three-dimensional image, three-dimensional measurement for finding position coordinates on the object T can be also performed using the calculated translation vector t and rotation matrix R of the image capture apparatuses 10P and 10Q. Moreover, it is possible to create three-dimensional CAD (Computer Aided Design) data on the basis of the found position coordinates. Furthermore, since geometric relationship between the two images 100P and 100Q is found, image compositing can be performed by translating or rotating one image 100P (or 100Q) to combine it with the other image 100Q (100P).

Although this embodiment employs the structure having light emitting units L₁ through L₈, such as laser pointers, for emitting light spots in the light emitting apparatus 20, it is not necessary to form optical image spots on the object T. For example, the invention can employ a light emitting apparatus capable of emitting light so as to form optical image slits or grids on the object T. Moreover, it is possible to employ a projector capable of forming predetermined optical images, in place of the light emitting apparatus 20.

Although this embodiment employs the structure for capturing images of the object T from different view points using two image capture apparatuses 10P and 10Q, three or more image capture apparatuses may be used. Moreover, it is also possible to capture images using one image capture apparatus, changing view points successively.

Furthermore, it is possible to use feature points extracted in the conventional method together with feature points extracted in the method of the present invention.

Second Embodiment

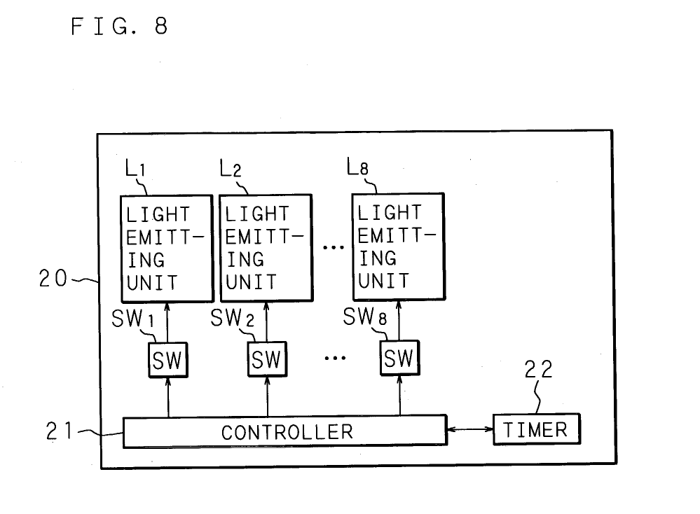

Description of this embodiment will explain an image processing system which can easily correlate feature points on images with each other, by temporally controlling each of the light emitting units L₁ through L₈ of the light emitting apparatus 20. The overall structure of the image processing system is nearly the same as that of the first embodiment. FIG. 8 is a block diagram of the light emitting apparatus 20 used in the image processing system according to this embodiment. The light emitting apparatus 20 comprises eight light emitting units L₁ through L₈. The light emitting units L₁ through L₈ are connected with the controller 21, respectively via switching units SW₁ through SW₈. The controller 21 is connected with a timer 22, and controls on/off of the switching units SW₁ through SW₈ on the basis of time information outputted from the timer 22. For example, when a switching unit SW₁ is turned on, the light emitting unit L₁ is turned on, while when the switching unit SW₁ is turned off, the light emitting unit L₁ is turned off. In such a manner, on/off of each of the light emitting units L₁ through L₈ is controlled temporally and separately.

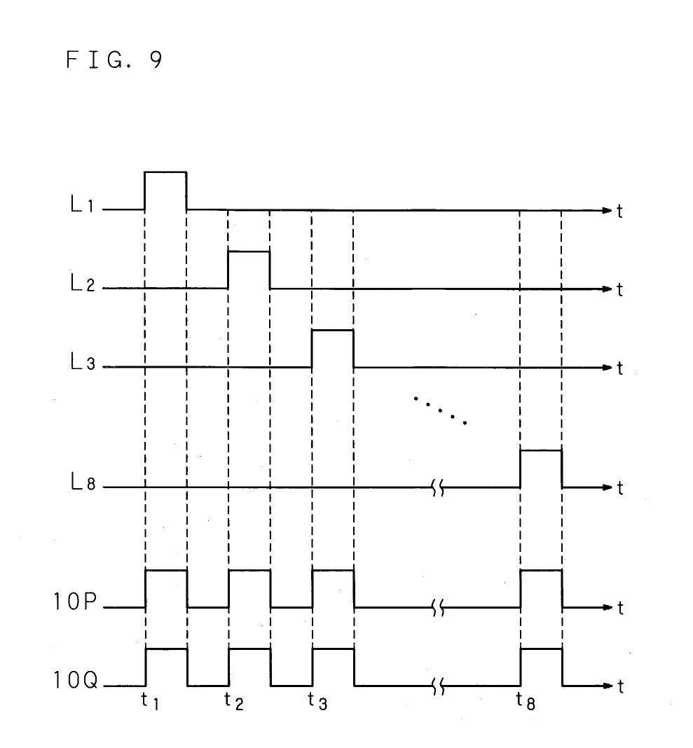

FIG. 9 includes time charts showing lighting timings of the light emitting units L₁ through L₈ and imaging timings of the image capture apparatuses 10P and 10Q. A time chart at the uppermost section of the figure shows a lighting timing of the light emitting unit L₁. When time t₁ passes after a predetermined time instant (supposing t=t₀), the controller 21 turns on the switching unit SW₁ to turn on the light emitting unit L₁. Then, when a predetermined time (for example, five seconds) passes, the controller 21 turns off the switching unit SW₁ to turn off the light emitting unit L₁. Next, when time t₂ passes after the time instant t=t₀, the controller 21 turns on the switching unit SW₂ to turn on the light emitting unit L₂. When a predetermined time further passes, the controller 21 turns off the light emitting unit L₂. Subsequently, the controller 21 successively turns on/off the light emitting units L₃ through L₈.

On the other hand, the image capture apparatuses 10P and 10Q capture images of the object T in a timing when any one of the light emitting units L₁ through L₈ is turned on. The image capture apparatuses 10P and 10Q may be constructed to automatically capture images in phase with lighting timings of the light emitting units L₁ through L₈, or constructed to manually capture images in phase with timings.

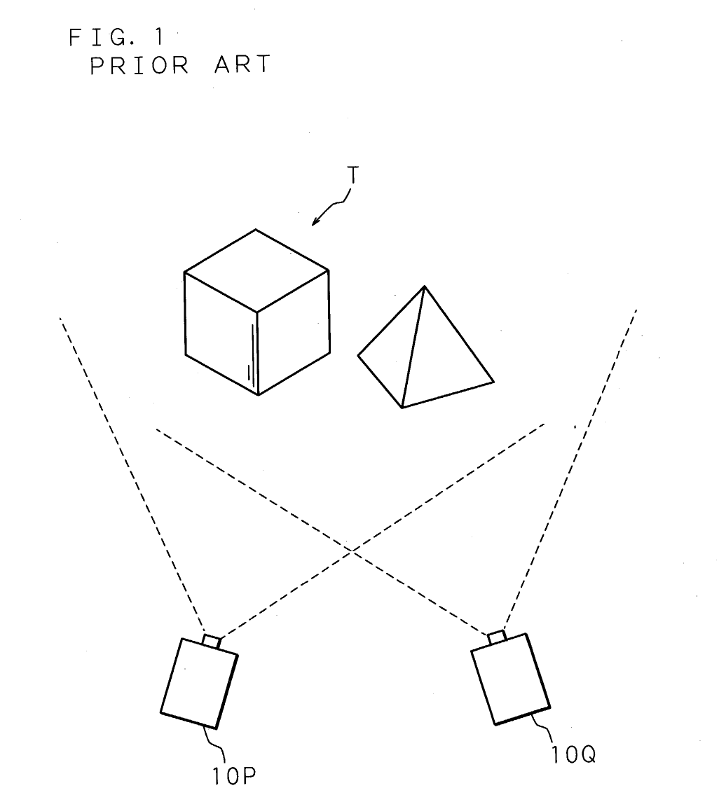

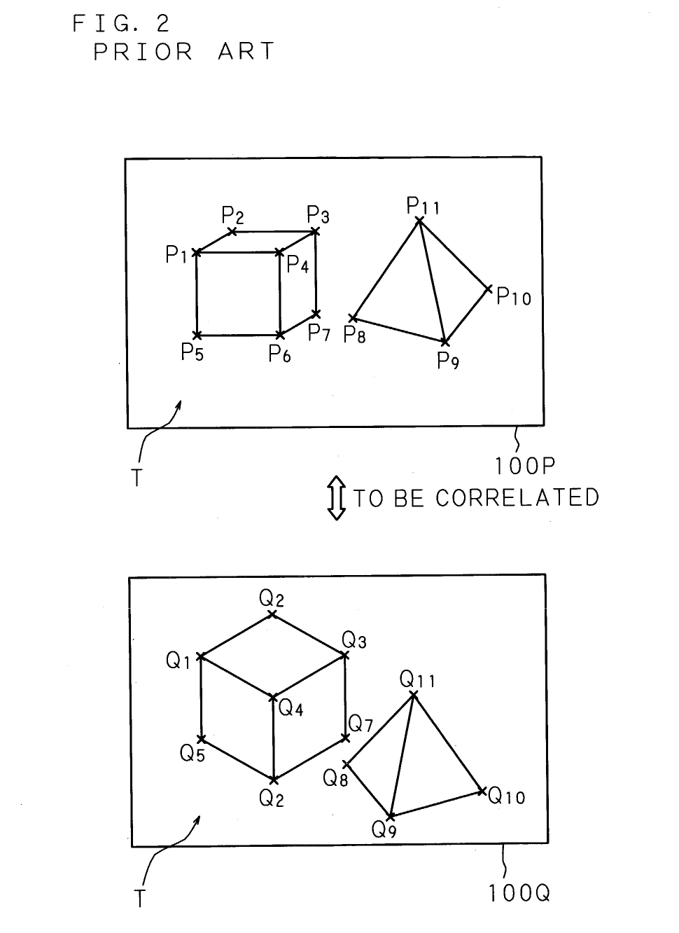

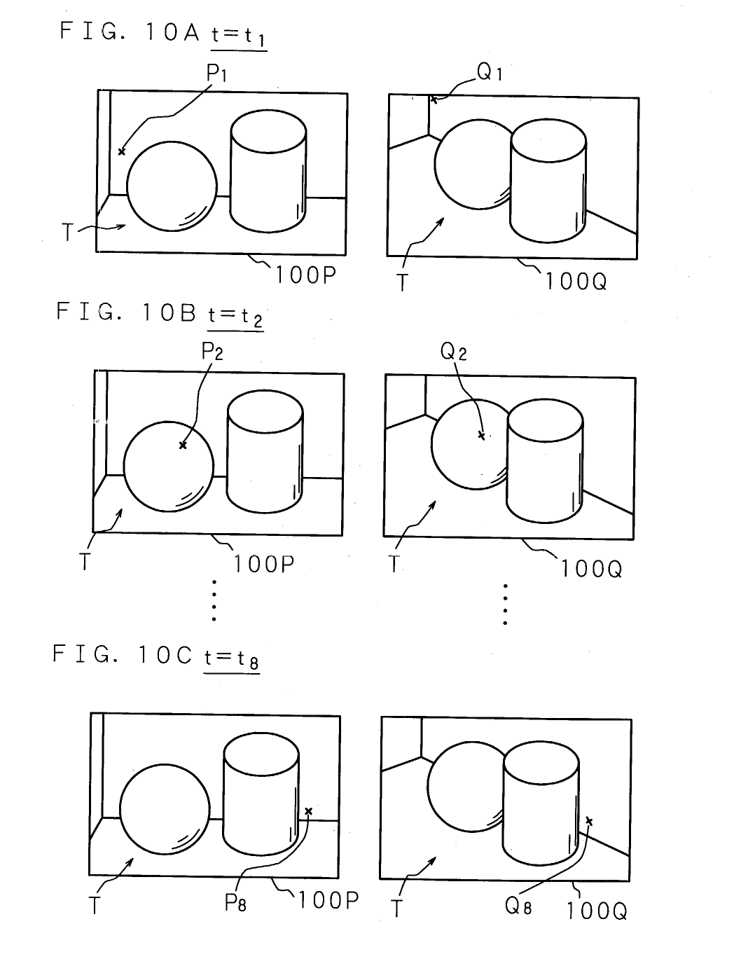

FIGS. 10A through 10C are schematic views for explaining the relationship between images captured by the image processing system according to this embodiment. FIG. 1A shows images captured at the time instant t=t₁, and the image 100P on the left side is an image of the object T captured by the image capture apparatus 10P, while the image 100Q on the right side is an image of the object T captured by the image capture apparatus 10Q. As explained using the time charts in FIG. 9, at the time instant t=t₁, both of the image capture apparatuses 10P and 10Q capture images with only the light emitting unit L₁ being turned on, so that only an optical image formed by light emitted from the light emitting unit L₁ shows up at the positions of points P₁ and Q₁. These points P₁ and Q₁ indicating the position of the optical image can be employed as feature points to be used for calculating positions and orientations of the image capture apparatuses 10P and 10Q, and the feature points can be easily correlated with each other as corresponding points.

Likewise, at the time instant t=t₂ shown in FIG. 10B, only the light emitting unit L₂ is turned on, so that only an optical image formed by light emitted from the light emitting unit L₂ shows up at the positions of points P₂ and Q₂. These points P₂ and Q₂ can be employed as feature points. Subsequently, feature points can be extracted respectively from images 100P and 100Q captured at the time instant t=t₃, t₄ , . . . , t₈, and can be easily correlated with each other.

As described above, in this embodiment, the light emitting apparatus 20 having a plurality of light emitting units L₁ through L₈ temporally controls a flashing timing of each of the light emitting units L₁ through L₈ when the two image capture apparatuses 10P and 10Q capture images of the object T. Consequently, only one optical image shows up in each image of the object T, and thereby feature points can be easily extracted and correlated with each other.

It should be noted that calculation of positions and orientations of the image capture apparatuses 10P and 10Q based on correspondence between feature points on images, creation of a three-dimensional image and the like can be performed in the same manner as in the first embodiment, and the explanation thereof is omitted here.

Third Embodiment

The first and second embodiments employ the structure for obtaining two-dimensional images of the object T using image capture apparatuses 10P and 10Q, such as silver salt film cameras or digital cameras, for capturing static images. However, it is also possible to use image capture apparatuses, such as analog video cameras or digital video cameras, for capturing moving images.

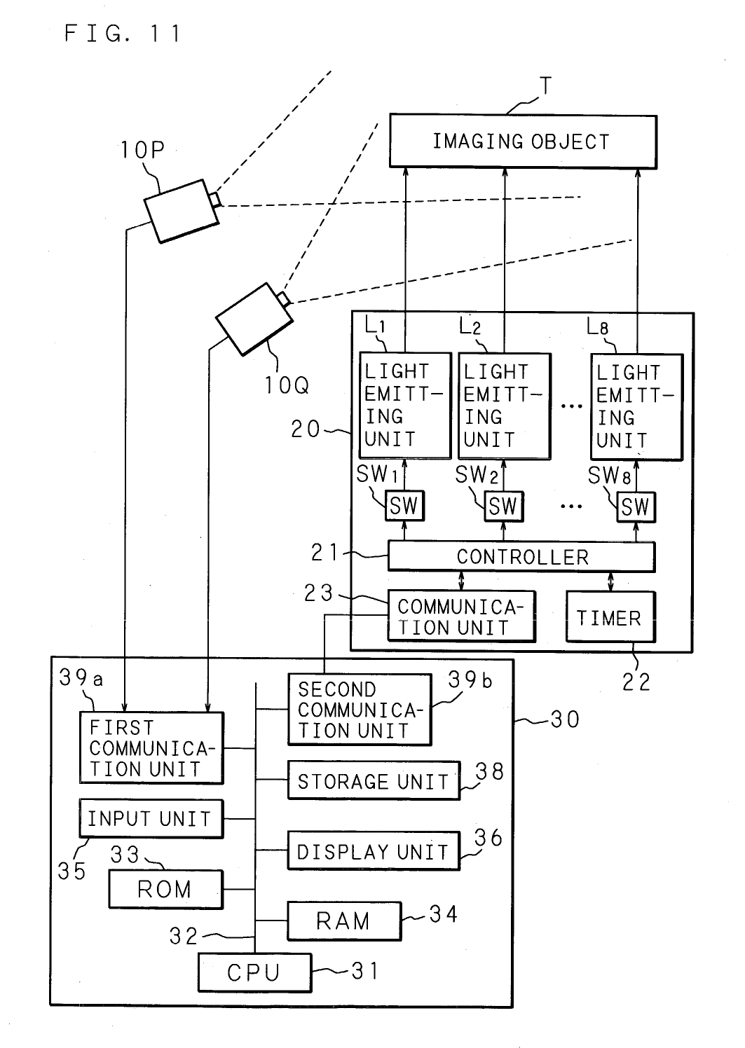

FIG. 11 is a block diagram showing the configuration of the image processing system according to this embodiment. In common with the first embodiment, the image processing system comprises two image capture apparatuses 50P and 50Q, a light emitting apparatus 20 and an image processing apparatus 30.

The image capture apparatuses 50P and 50Q are analog video cameras, digital video cameras or the like. Images captured by the image capture apparatuses 50P and 50Q are transmitted to the image processing apparatus 30 which is connected with the image capture apparatuses 50P and 50Q.

The light emitting apparatus 20 comprises a controller 21 for controlling on/off of light emitting units L₁ through L₈, and a timer 22 connected to the controller 21. The controller 21 turns on/off switching units SW₁ through SW₈ respectively connected to the light emitting units L₁ through L₈, to turn on/off the light. The controller 21 is connected with a communication unit 23, so as to receive control signals transmitted from the image processing apparatus 30. The controller 21 judges whether light should be turned on or off on the basis of the received control signals, and controls on/off of the switching units SW₁ through SW₈.

The image processing apparatus 30 comprises a first communication unit 39a for receiving image frames transmitted from the image capture apparatuses 50P and 50Q, and a second communication unit 39b connected to the communication unit 23 of the light emitting apparatus 20. Image frames received by the first communication unit 39a is stored in the RAM 34 or storage unit 38. The CPU 31 generates control signals indicating information on on/off timings of the light emitting units L₁ through L₈, and transmits the control signals through the second communication unit 39b.

The image processing apparatus 30 analyzes image frames including optical images formed by light emitted from the light emitting units L₁ through L₈, extracts feature points in the method described above, and correlates the feature points with each other.

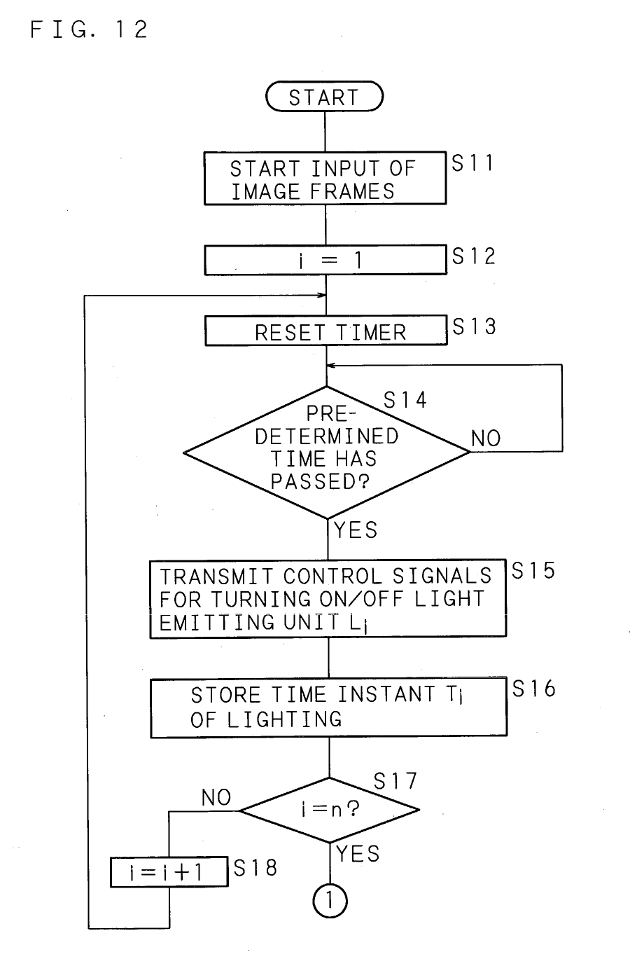

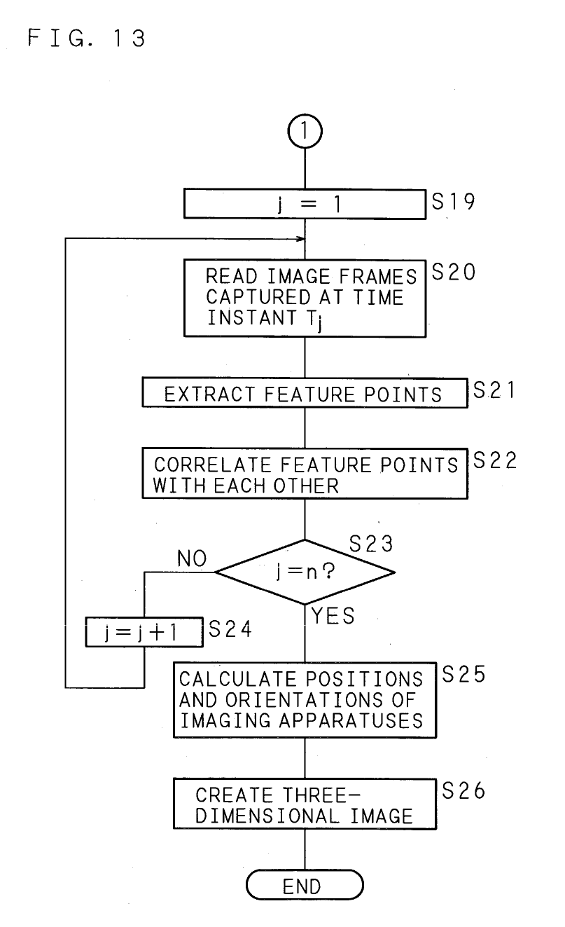

FIGS. 12 and 13 are flow charts for explaining the processing procedure of the image processing apparatus 30 according to this embodiment. First, the images processing apparatus 30 receives image frames transmitted from the image capture apparatuses 50P and 50Q through the first communication unit 39a, and starts inputting the image frames (step S11). The images processing apparatus 30 then sets a counter thereof as i=1 (step S12) and resets a timer which is not illustrated in figures (step S13).

With reference to time outputted by the timer, the CPU 31 of the image processing apparatus 30 judges whether a predetermined time has passed or not (step S14). When it is judged that a predetermined time has not passed (S14: NO), the CPU 31 waits until a predetermined time passes.

When it is judged that a predetermined time has passed (S14: YES), the CPU 31 transmits control signals for turning on/off a light emitting unit Lᵢ, via the second communication unit 39b to the light emitting apparatus 20 (step S15), and instructs the RAM 34 to store the time instant Tᵢ when the light emitting unit Lᵢ is turned on (step S16).

The CPU 31 then judges whether the value i of the counter has come to a predetermined value n (for example, n=8) or not (step S17). When it judged that the value i of the counter has not come to a predetermined value n (S17: NO), the CPU 31 adds 1 to the value i of the counter (step S18), and the process goes back to the step S13.

When it is judged that the value i of the counter has come to a predetermined value n (S17: YES), the CPU 31 sets another value j of the counter to 1 (step S19), retrieves image frames captured by the image capture apparatuses 50P and 50Q at the time instant Tⱼ and reads the image frames (step S20), and instructs the storage unit 38 of the image processing apparatus 30 to store the image frames temporarily.

The CPU 31 of the image processing apparatus 30 extracts feature points from each of the two images read in the step S20 (step S21), and correlates the feature points with each other (step S22). Since the CPU 31 controls on/off of each of the light emitting apparatuses L₁ through L₈ in different timings in steps S12 through S17, each image frame includes only one optical image formed by light emitted from a light emitting unit Lᵢ (i=1˜8). Consequently, image frames can be easily correlated with each other using feature points extracted on the basis of the optical image.

The CPU 31 then judges whether the value j of the counter has come to a predetermined value n or not (step S23). When it is judged that the value j has not come to a predetermined value n (S23: NO), the CPU 31 adds 1 to the value j of the counter (step S24), and then the process goes back to the step S20.

When it is judged that the value j of the counter has come to a predetermined value (S23: YES), the CPU 31 calculates positions and orientations of the image capture apparatuses 50P and 50Q on the basis of a plurality of determined pairs of corresponding points in the method described above (step S25). With this embodiment, eight pairs of corresponding points can be determined in the image frames, a fundamental matrix F can be obtained using the eight pairs of corresponding points, and thereby a translation vector t and a rotation matrix R of the image capture apparatuses 50P and 50Q can be obtained.

On the basis of the calculated positions and orientations of the image capture apparatuses 50P and 50Q, the CPU 31 creates a three-dimensional image (step S26). Since the translation vector t and rotation matrix R of the image capture apparatuses 50P and 50Q are obtained in the step S25, position coordinates on images (image frames) can be transformed into position coordinates of a three-dimensional space in an object frame using the expressions (1) and (2), to restructure a three-dimensional image.

It should be noted that, although this embodiment employs the structure for creating a three-dimensional image, it is also possible to perform three-dimensional measurement for finding position coordinates on the object T, using the obtained translation vector t and rotation matrix R of the image capture apparatuses 50P and 50Q. Moreover, it is possible to create three-dimensional CAD data using the found position coordinates. Furthermore, on the basis of the found geometric relationship between two images, image compositing can be performed by translating or rotating one image to combine it with the other image.

As described above, with this embodiment which employs image capture apparatuses 50P and 50Q for capturing moving images, it is not necessary to capture images in phase with flashing timings of respective light emitting units L₁ through L₈ of the light emitting apparatus 20. However, if the invention is constructed so that information on flashing timings is transmitted from the communication unit 23 to the second communication unit 39b, image frames including optical images formed by emitted light can be retrieved on the basis of the information, and feature points on image frames can be easily correlated with each other.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. An image processing method comprising steps of:
emitting light on an object;
capturing images of the object by an image capture apparatus;
reading a plurality of images, captured with light being emitted on the object, into an image processing apparatus;
calculating positional information of an optical image formed on the object by the emitted light, on the basis of each of the read images;
determining corresponding points on respective images which correspond to each other, on the basis of the calculated positional information of the optical image; and
calculating positions and orientations of the image capture apparatus at the time of capturing the images of the object, on the basis of the determined corresponding points.

2. An image processing system comprising:
a light emitting apparatus for emitting light on an object;
an image capture apparatus for capturing an image of the object; and
an image processing apparatus capable of performing operations of:
reading a plurality of images captured by the image capture apparatus with light being emitted by the light emitting apparatus;
calculating positional information of an optical image formed on the object by the emitted light, on the basis of each of the read images;
determining corresponding points on respective images which correspond to each other, on the basis of the calculated positional information of the optical image; and
calculating positions and orientations of the image capture apparatus at the time of capturing the images of the object, on the basis of the determined corresponding points.

3. The image processing system according to claim 2, wherein the light emitting apparatus emits at least one light spot.

4. The image processing system according to claim 3, wherein the light emitting apparatus controls on/off of each emitted light spot.

5. The image processing system according to claim 4, further comprising a timing unit, wherein the light emitting apparatus controls the on/off on the basis of time outputted from the timing unit.

6. The image processing system according to claim 2, wherein the light emitting apparatus emits a plurality of light spots having respectively unique colors.

7. The image processing system according to claim 6, wherein the light emitting apparatus controls on/off of each emitted light spot.

8. The image processing system according to claim 7, further comprising a timing unit, wherein the light emitting apparatus controls the on/off on the basis of time outputted from the timing unit.

9. An image processing system comprising:
a light emitting apparatus for emitting light on an object;
an image capture apparatus for capturing an image of the object; and
an image processing apparatus which includes:
means for reading a plurality of images captured by the image capture apparatus with light being emitted by the light emitting apparatus;
means for calculating positional information of an optical image formed on the object by the emitted light, on the basis of each of the read images;
means for determining corresponding points on respective images which correspond to each other, on the basis of the calculated positional information of the optical image; and
means for calculating positions and orientations of the image capture apparatus at the time of capturing the images of the object, on the basis of the determined corresponding points.

10. The image processing system according to claim 9, wherein the light emitting apparatus includes means for emitting at least one light spot.

11. The image processing system according to claim 10, wherein the light emitting apparatus further includes control means for controlling on/off of each emitted light spot.

12. The image processing system according to claim 11, further comprising timing means, wherein the control means controls the on/off on the basis of time outputted from the timing means.

13. The image processing system according to claim 9, wherein the light emitting apparatus includes means for emitting a plurality of light spots having respectively unique colors.

14. An image processing apparatus capable of performing operations of:
reading a plurality of images captured by an image capture apparatus with light being emitted on an object;
calculating positional information of an optical image formed on the object by the emitted light, on the basis of each of the read images;
determining corresponding points on respective images which correspond to each other, on the basis of the calculated positional information of the optical image; and
calculating positions and orientations of the image capture apparatus at the time of capturing the images of the object, on the basis of the determined corresponding points.

15. The image processing apparatus according to claim 14, which is capable of obtaining a three-dimensional image of the object, on the basis of the calculated positions and orientations of the image capture apparatus.

16. The image processing apparatus according to claim 14, which is capable of creating a composite image using the images, on the basis of the calculated positions and orientations of the image capture apparatus.

17. An image processing apparatus comprising:
means for reading a plurality of images captured by an image capture apparatus with light being emitted on an object;
means for calculating positional information of an optical image formed on the object by the emitted light, on the basis of each of the read images;
means for determining corresponding points on respective images which correspond to each other, on the basis of the calculated positional information of the optical image; and
means for calculating positions and orientations of the image capture apparatus at the time of capturing the images of the object, on the basis of the determined corresponding points.

18. The image processing apparatus according to claim 17, further comprising means for obtaining a three-dimensional image of the object, on the basis of the calculated positions and orientations of the image capture apparatus.

19. The image processing apparatus according to claim 17, further comprising means for creating a composite image using the images, on the basis of the calculated positions and orientations of the image capture apparatus.
